(19) United States
(12) Patent Application Publication
(10) Pub. No.: US 2026/0328669 A1
(43) Pub. Date: Oct. 22, 2026

(54) DETECTION DEVICE

(71) Applicant: Japan Display Inc., Tokyo (JP)

(72) Inventors: Kaoru ITO, Tokyo (JP); Norio MAMBA, Tokyo (JP); Daichi ABE, Tokyo (JP); Yoshihiro SEKIGUCHI, Tokyo (JP)

(21) Appl. No.: 19/650,498

(22) Filed: Apr. 17, 2026

(30) Foreign Application Priority Data
Apr. 18, 2025 (JP) 2025-068651

(51) Int. Cl. G01N 15/075; G01K 3/00; G01K 3/10; G01N 25/66

(52) U.S. Cl. CPC G01N 15/075; G01K 3/005; G01K 3/10; G01N 25/66

(57) ABSTRACT

According to an aspect, a detection device includes: a light source; a planar optical sensor with optical sensors; an object placement member; and a processor. Each optical sensor includes a photodiode, a source follower transistor, and a switching element. The processor is configured to obtain an output from a source of the source follower transistor at each of a first time after the switching element has been turned from on to off and a second time during a period when the switching element is on. The output obtained at the first time during a period when light is emitted from the light source is an output for detecting an intensity of the light detected by the optical sensor. The output obtained at the second time during a period when no light is emitted from the light source is an output indicating a temperature of the planar optical sensor.

### CROSS-REFERENCE TO RELATED APPLICATION

This application claims the benefit of priority from Japanese Patent Application No. 2025-068651 filed on Apr. 18, 2025, the entire contents of which are incorporated herein by reference.

### BACKGROUND

### 1. Technical Field

What is disclosed herein relates to a detection device.

### 2. Description of the Related Art

Devices are known that detect an intensity of light transmitted through a culture medium (e.g., agar) for culturing samples to be cultured such as bacteria, and thereby, detect colonies of the samples to be cultured on the culture medium (for example, Japanese Patent Application Laid-open Publication No. 2012-080802 (JP-A-2012-080802)).

In devices that detect colonies, such as that described in JP-A-2012-080802, a function to detect temperature is required because environmental conditions for growing the samples to be cultured on the culture medium include conditions related to temperature, in some cases.

For the foregoing reasons, there is a need for a detection device capable of detecting the light intensity and the temperature.

### SUMMARY

According to an aspect, a detection device includes: a light source configured to emit light; a planar optical sensor where a plurality of optical sensors configured to detect the light from the light source are two-dimensionally arranged; an object placement member provided so as to allow an object to be detected to be placed such that the object to be detected is interposed between the light source and the planar optical sensor; and a processor configured to perform operation control of the light source and the planar optical sensor and processing based on a plurality of outputs of the optical sensors. Each of the optical sensors includes: a photodiode, an anode of which is configured to be supplied with a reference potential; a source follower transistor, a gate of which is coupled to a cathode of the photodiode; and a switching element, one of a source and a drain of which is coupled to the cathode of the photodiode and a gate of the source follower transistor, and the other of the source and the drain of which is configured to be supplied with a reset potential. The processor is configured to obtain an output from a source of the source follower transistor at each of a first time and a second time, the first time is a predetermined time after the switching element has been turned from on to off, and the second time is a time during a period when the switching element is on. The output obtained from the source of the source follower transistor at the first time during a period when the light is emitted from the light source is an output for detecting an intensity of the light detected by the optical sensor. The output obtained from the source of the source follower transistor at the second time during a period when no light is emitted from the light source is an output indicating a first temperature that is a temperature of the planar optical sensor.

### BRIEF DESCRIPTION OF THE DRAWINGS

FIG. 1 is a diagram illustrating a main configuration of a detection device;

FIG. 2 is a diagram illustrating a configuration example of a detection area and a wiring area;

FIG. 3 is a circuit diagram illustrating a circuit configuration of an optical sensor;

FIG. 4 illustrates schematic views illustrating configuration examples of a light source;

FIG. 5 is a schematic diagram schematically illustrating a configuration example of a detection system;

FIG. 6 is a schematic diagram illustrating a relation between one detection device and an external configuration;

FIG. 7 is a schematic view illustrating a structure of various parts including main components of the detection device and an object to be detected that is placed on the detection device;

FIG. 8 is a schematic diagram illustrating a main configuration used for detection of temperature;

FIG. 9 is a timing diagram illustrating an operation timing sequence of each of switching elements used for detection of a light intensity;

FIG. 10 is a timing diagram illustrating the relations of the operation timing of each of the switching elements with a reset potential and a reference potential in a first embodiment of the present disclosure;

FIG. 11 is a timing diagram illustrating the relations of the operation timing of each of the switching elements with the reset potential and the reference potential in a second embodiment of the present disclosure;

FIG. 12 is a schematic view illustrating a configuration in a housing according to a first modification of the present disclosure;

FIG. 13 is a schematic view illustrating an arrangement of heaters in plan view;

FIG. 14 is a schematic view illustrating an exemplary arrangement of a temperature sensor different from that in FIG. 12;

FIG. 15 is a schematic view illustrating an example of an area within which an output of a source follower transistor is obtained to detect the temperature of a planar optical sensor; and

FIG. 16 is a schematic view illustrating an example of an area within which the output of the source follower transistor is obtained to detect the temperature of the planar optical sensor.

### DETAILED DESCRIPTION

The following describes embodiments of the present disclosure with reference to the drawings. What is disclosed herein is merely an example, and the present disclosure naturally encompasses appropriate modifications easily conceivable by those skilled in the art while maintaining the gist of the present disclosure. To further clarify the description, the drawings may schematically illustrate, for example, widths, thicknesses, and shapes of various parts as compared with actual aspects thereof. However, they are merely examples, and interpretation of the present disclosure is not limited thereto. The same element as that described with reference to an already mentioned drawing is denoted by the same reference numeral through the present specification and the drawings, and detailed description thereof may not be repeated where appropriate.

### First Embodiment

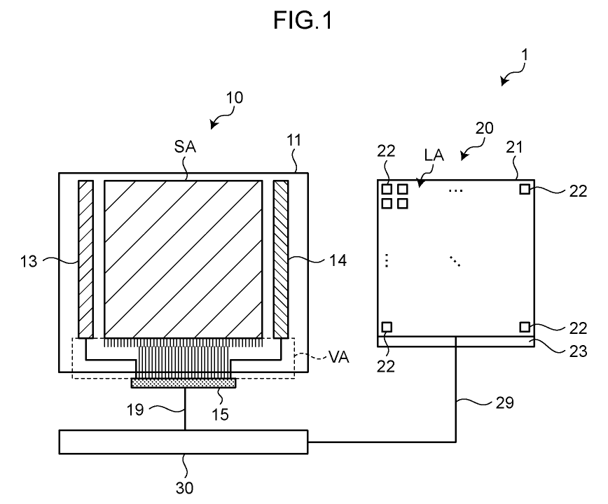

FIG. 1 is a diagram illustrating a main configuration of a detection device 1. The detection device 1 includes a planar optical sensor 10, a light source panel 20, and a control circuit 30. The planar optical sensor 10 and the light source panel 20 of the detection device 1 are coupled to the control circuit 30.

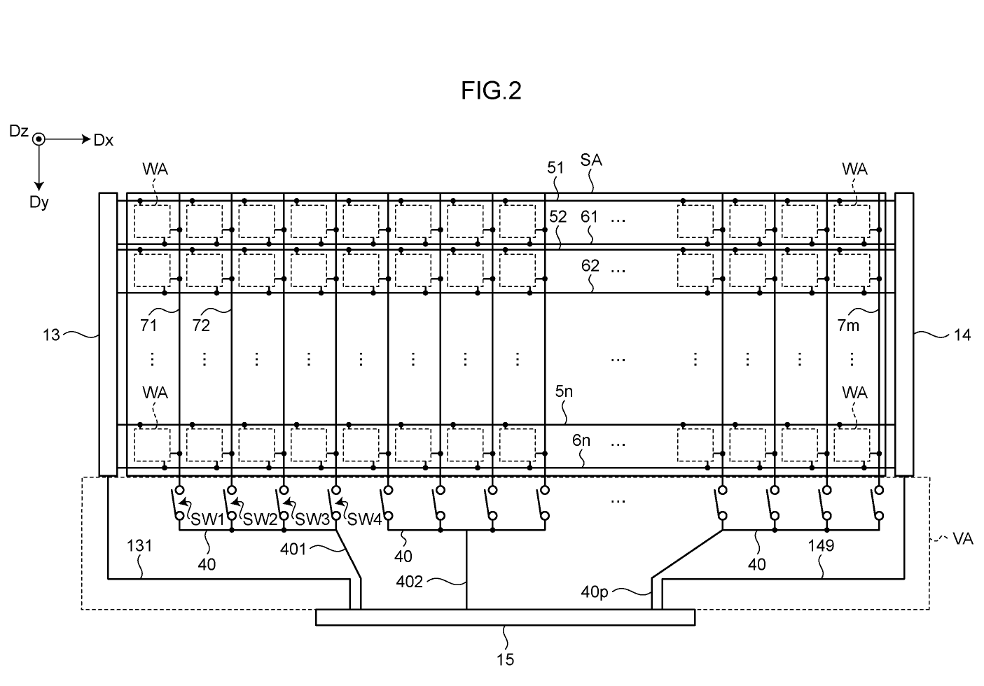

The planar optical sensor 10 is provided with a detection area SA (refer to FIG. 2) on a substrate 11. A reset circuit 13, a scan circuit 14, and a wiring area VA are provided on the substrate 11. Components on the detection area SA, the reset circuit 13, and the scan circuit 14 are coupled to a detection circuit 15 via the wiring area VA.

The light source panel 20 has a light-emitting area LA that emits light to the detection area SA. The light source panel 20 is provided with a light source 22 on a substrate 21. The light source 22 emits light. Specifically, the light source 22 includes a light-emitting element such as a light-emitting diode (LED) and is provided in the light-emitting area LA. In the example illustrated in FIG. 1, a plurality of the light sources 22 are arranged in a matrix having a row-column configuration on the substrate 21.

The light source panel 20 is provided with a light source drive circuit 23. Under the control of the control circuit 30, the light source drive circuit 23 controls turning on and off of each of the light sources 22 and the luminance thereof when being turned on. The light sources 22 may be provided to allow individual control of light emission or may be provided so as to emit light collectively.

The control circuit 30 performs various processes related to operations of the detection device 1. Specifically, the control circuit 30 is a circuit, such as a field-programmable gate array (FPGA) that can implement a plurality of functions. The control circuit 30 may have other configurations, such as an application-specific integrated circuit (ASIC). The control circuit 30 is coupled to the light source drive circuit 23 via wiring 29 and performs processing related to the lighting of the light sources 22, such as determination of lighting patterns and lighting timing of the light sources 22.

The control circuit 30 is coupled to the detection circuit 15 via wiring 19 and obtains an output from the detection circuit 15. The control circuit 30 also controls the timing of obtaining the output from the detection circuit 15, that is, the timing of operating the scan circuit 14 so as to provide a gate signal to a scan line 6. Thus, the control circuit 30 controls operations of the light sources 22 and the planar optical sensor 10. The control circuit 30 further performs processes based on outputs of a plurality of optical sensors WA. Such processes includes a process to determine whether an object to be detected 200 has been relocated, a process to determine whether colonies have been formed, and other processes. These processes will be described later.

Although not illustrated in the drawings, the detection device 1 includes an analog-to-digital conversion circuit, a digital-to-analog conversion circuit, and other components. The analog-to-digital conversion circuit is a circuit for allowing the outputs from the optical sensors WA (refer to FIG. 2) transmitted via the detection circuit 15 to be handled in arithmetic processing by the control circuit 30. The digital-to-analog conversion circuit is a circuit for allowing digital signals generated by the arithmetic processing of the control circuit 30 to be used for controlling the operations of the planar optical sensor 10 and the light source panel 20. These circuits may be included, for example, in part or in whole in the detection circuit 15. These circuits may alternatively be functions performed by circuits mounted on flexible printed circuits (FPCs) provided as the wiring 19 and the wiring 29. These circuits may alternatively be mounted in other ways on the detection device 1.

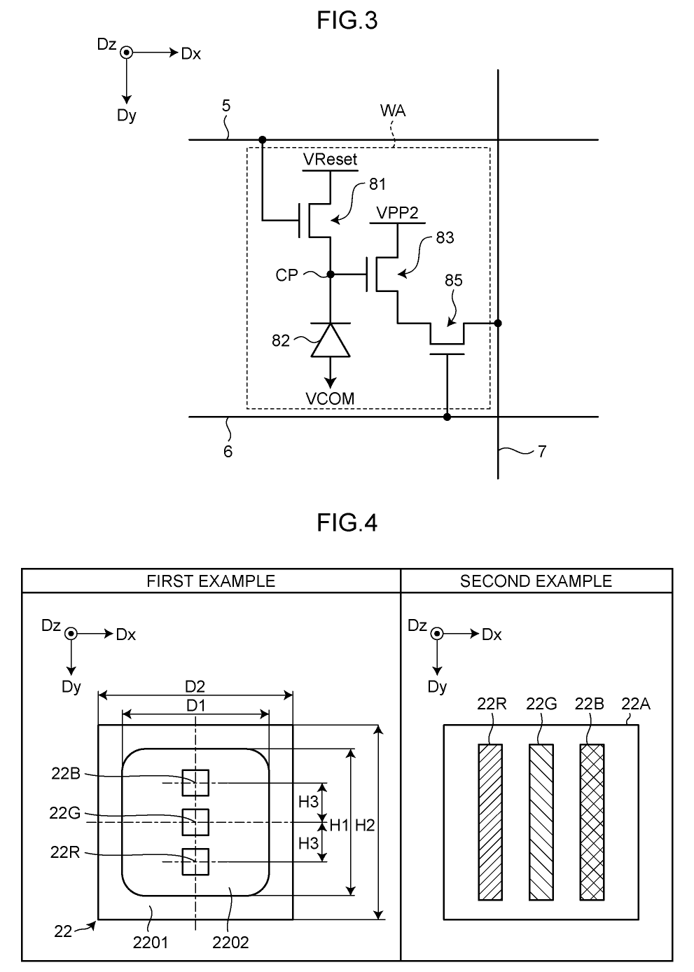

FIG. 2 is a diagram illustrating a configuration example of the detection area SA and the wiring area VA. The multiple optical sensors WA (FIG. 3) are two-dimensionally arranged in the detection area SA of the planar optical sensor 10. In a first embodiment of the present disclosure, as illustrated in FIG. 2, the optical sensors WA are arranged in a matrix having a row-column configuration along a first direction Dx and a second direction Dy. The first direction Dx is orthogonal to the second direction Dy. In the following description, the term "third direction Dz" refers to a direction orthogonal to the first direction Dx and the second direction Dy.

The reset circuit 13 is coupled to reset signal transmission lines 51, 52, ..., 5n. Hereinafter, the term "reset signal transmission line 5" refers to any one of the reset signal transmission lines 51, 52, ..., 5n. The reset signal transmission line 5 is wiring along the first direction Dx. In the example illustrated in FIG. 2, n reset signal transmission lines 5 are arranged in the second direction Dy. n is a natural number equal to or larger than 2. The n reset signal transmission lines 5 are each coupled, at one end in the first direction Dx, to the reset circuit 13.

The scan circuit 14 is coupled to scan lines 61, 62, ..., 6n. Hereinafter, the term "scan line 6" refers to any one of the scan lines 61, 62, ..., 6n. The scan line 6 is wiring along the first direction Dx. In the example illustrated in FIG. 2, n scan lines 6 are arranged in the second direction Dy. The n scan lines 6 are each coupled, at the other end in the first direction Dx, to the scan circuit 14.

As illustrated in FIG. 2, the reset signal transmission lines 5 and the scan lines 6 are alternately arranged in the second direction Dy in the detection area SA. The reset circuit 13 and the scan circuit 14 illustrated in FIGS. 1 and 2 are arranged at locations facing each other with the detection area SA interposed therebetween, but the layout of the reset circuit 13 and the scan circuit 14 is not limited to this layout and can be changed as appropriate.

Signal lines 71, 72, ..., 7m are also provided in the detection area SA. Hereinafter, the term "signal line 7" refers to any one of the signal lines 71, 72, ..., 7m. The signal line 7 is wiring along the second direction Dy.

In the example illustrated in FIG. 2, m signal lines 7 are arranged in the first direction Dx. m is a natural number equal to or larger than 2. The m signal lines 7 are each coupled, at one end in the second direction Dy, to one of a plurality of switches (for example, a switch SW1, a switch SW2, a switch SW3, or a switch SW4) included in a multiplexer 40.

The multiplexer 40 is provided in the wiring area VA. The multiplexer 40 includes a plurality of switches. In the example illustrated in FIG. 2, the switches SW1, SW2, SW3, and SW4 are illustrated as the switches. The switches included in one multiplexer 40 are turned on (conducting state) at different times from one another. During a period when one of the switches included in one multiplexer 40 is on (conducting state), the other switches are off (non-conducting state). The number of the multiplexers 40 corresponds to the number (m) of the signal lines 7. When the number of the switches is p, m/p is sufficient as the number of the multiplexers 40. When more than one multiplexer 40 are provided, each of the multiplexers 40 is coupled to the detection circuit 15 via an individual one of wiring lines 401, 402, ..., 40p.

The coupling between the signal lines 7 and the detection circuit 15 via the multiplexer 40 is merely exemplary and is not limited to this example. The signal lines 7 may be individually directly coupled to the detection circuit 15 in the wiring area VA. In the wiring area VA, the reset circuit 13 is coupled to the detection circuit 15 via wiring 131. In the wiring area VA, the scan circuit 14 is coupled to the detection circuit 15 via wiring 149.

In the detection of light by a photodiode (PD) 82 (refer to FIG. 3) provided in the optical sensor WA, the detection circuit 15 outputs signals to control operation timing of the reset circuit 13 and the scan circuit 14 under the control of the control circuit 30. The detection circuit 15 receives the outputs from the optical sensors WA. The detection circuit 15 converts the signals received from the optical sensors WA into data that can be interpreted by the control circuit 30 and outputs the data to the control circuit 30. The detection circuit 15 of the first embodiment is a microcontroller unit (MCU).

FIG. 3 is a circuit diagram illustrating a circuit configuration of the optical sensor WA. The first direction Dx and the second direction Dy in FIG. 3 merely correspond to the directions of the reset signal transmission lines 5, the scan lines 6, and the signal lines 7, and do not exactly indicate the relative positional relation of the circuit configuration in the optical sensor WA.

As illustrated in FIG. 3, a switching element 81, the PD 82, a source follower transistor 83, and a switching element 85 are provided in the optical sensor WA. The PD 82 is a photodiode (PD). The switching elements 81 and 85 and the transistor element are metal-oxide semiconductor field-effect transistors (MOSFETs).

The gate of the switching element 81 is coupled to the reset signal transmission line 5. One of the source and the drain of the switching element 81 is supplied with a reset potential VReset. The other of the source and the drain of the switching element 81 is coupled to the cathode of the PD 82 and the gate of the source follower transistor 83. Hereinafter, the term "coupling part CP" refers to a point where the other of the source and the drain of the switching element 81 is coupled to the cathode of the PD 82 and the gate of the source follower transistor 83. A reference potential VCOM is supplied from the anode side of the PD 82. The potential difference between the reset potential VReset and the reference potential VCOM is set in advance, but the reset potential VReset and the reference potential VCOM may be variable. The reset potential VReset is higher than the reference potential VCOM.

The drain of the source follower transistor 83 serving as a source follower is supplied with a potential VPP2. The source of the source follower transistor 83 is coupled to one of the source and the drain of the switching element 85. The other of the source and the drain of the switching element 85 is coupled to the signal line 7. The gate of the switching element 85 is coupled to the scan line 6.

The reset potential VReset, the reference potential VCOM, and the potential VPP2 are supplied by the detection circuit 15 to the optical sensor WA based on, for example, electric power supplied via a power supply circuit (not illustrated) coupled to the detection circuit 15. The way of outputting these potentials is not limited to this way and can be changed as appropriate.

The potential VPP2 is set in advance. The potential on the source side of the source follower transistor 83 is a potential lower than the output potential of the PD 82 by a voltage (Vth) between the gate and the source of the source follower transistor 83. In this case, the potential on the source side of the source follower transistor 83 corresponds to the reset potential VReset and the reference potential VCOM. The potential of the output of the PD 82 corresponds to photovoltaic power generated by the PD 82 in response to the light detected by the PD 82 during an exposure period.

When the gate of the switching element 85 is turned on by the gate signal supplied from the scan circuit 14 via the scan line 6, the source and the drain of the switching element 85 are brought into a conducting state therebetween. This operation transmits, to the signal line 7 via the switching element 85, a signal (potential) transmitted via the source follower transistor 83 to the switching element 85. Thus, the output from the optical sensor WA is generated. Hereinafter, the term "gate signal" refers to the signal (potential) supplied from the scan circuit 14 via the scan line 6. The scan circuit 14 is a circuit that outputs the gate signal. As described with reference to FIGS. 2 and 3, the optical sensors WA coupled to the scan lines 6 and the signal lines 7 are arranged in a matrix having a row-column configuration in the detection area SA of the planar optical sensor 10. The scan line 6 is provided along the first direction Dx and is configured to transmit the gate signal that causes the optical sensors WA to generate the outputs. The signal line 7 is configured to transmit the outputs of the optical sensors WA along the second direction Dy.

The output of one PD 82 included in one optical sensor WA corresponds to the intensity of the light detected by the PD 82 during the exposure period set in advance. The output of the PD 82 is reset in response to a signal supplied by the reset circuit 13 via the reset signal transmission line 5. When the signal turns on the gate of the switching element 81, the source and the drain of the switching element 81 are brought into a conducting state therebetween. This operation resets the potential of the coupling part CP to the reset potential VReset.

As described above with reference to FIG. 3, the optical sensor WA includes the photodiode (PD 82), the source follower transistor (source follower transistor 83), and the switching element (switching element 81). The photodiode (PD 82) has an anode that is supplied with the reference potential (reference potential VCOM). The source follower transistor (source follower transistor 83) has a gate that is coupled to the cathode of the photodiode. The switching element (switching element 81) has a source and a drain, one of the source and the drain is coupled to the cathode of the photodiode and the gate of the source follower transistor, and the other of the source and the drain is supplied with the reset potential (reset potential VReset). That is, the source follower transistor 83 of the first embodiment corresponds to a source follower transistor in the present disclosure. The switching element 81 of the first embodiment corresponds to a switching element in the present disclosure.

FIG. 4 illustrates schematic views illustrating configuration examples of the light source 22. As illustrated in FIG. 4, the light source 22 includes a first light source 22R, a second light source 22G, and a third light source 22B. The first light source 22R, the second light source 22G, and the third light source 22B emit light in different colors from one another. In the first embodiment, the first light source 22R emits red (R) light. The second light source 22G emits green (G) light. The third light source 22B emits blue (B) light.

As illustrated as "First Example" in FIG. 4, the light source 22 has, for example, a light-emitting area 2202 and a frame area 2201. In the light-emitting area 2202, the first light source 22R, the second light source 22G, and the third light source 22B that are square in shape in plan view are arranged along the second direction Dy. The frame area 2201 is a frame-like area surrounding the light-emitting area 2202. A width D1 in the first direction Dx of the light-emitting area 2202 is smaller than a width D2 in the first direction Dx of the frame area 2201. A height H1 in the second direction Dy of the light-emitting area 2202 is smaller than a height H2 in the second direction Dy of the frame area 2201. The distance between the first light source 22R and the second light source 22G is a distance H3, and the distance between the second light source 22G and the third light source 22B is also the distance H3. The distance H3 is less than half the height H1. In "First Example" in FIG. 4, the width D1 is equal to the height H1, and the width D2 is equal to the height H2, but at least one of the widths may differ from a corresponding one of the heights. The light source 22 may be replaced with a light source of another form, specifically, such as a light source 22A illustrated in "Second Example" in FIG. 4. In the light source 22A, the longitudinal directions of the first light source 22R, the second light source 22G, and the third light source 22B are along the second direction Dy, and the first light source 22R, the second light source 22G, and the third light source 22B are arranged in this order from one side toward the other side in the first direction Dx. First Example and Second Example in FIG. 4 are exemplary forms of the light source according to the present disclosure, which is not limited to these examples. The shapes of the first light source 22R, the second light source 22G, and the third light source 22B in plan view and the positional relation between the first light source 22R, the second light source 22G, and the third light source 22B can be changed as appropriate. The term "plan view" refers to a view when a plane along the first direction Dx and the second direction Dy (Dx-Dy plane) is viewed face-to-face.

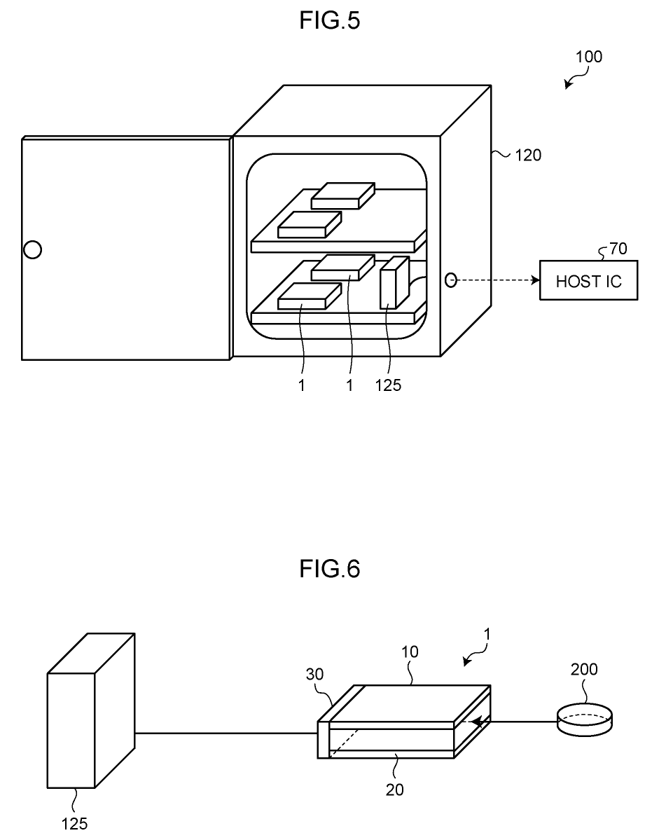

FIG. 5 is a schematic diagram schematically illustrating a configuration example of a detection system 100 including the detection device 1. As illustrated in FIG. 5, the detection system 100 includes a plurality of the detection devices 1, a host integrated circuit (IC) 70, and a coupling circuit 125. The detection devices 1 are electrically coupled to the common host IC 70 via the coupling circuit 125.

An incubator 120 illustrated in FIG. 5 is maintained such that an environment (temperature, humidity, and the like) therein is suitable for culturing biological samples on the object to be detected 200 while a door is closed. The detection devices 1 are placed in the incubator 120.

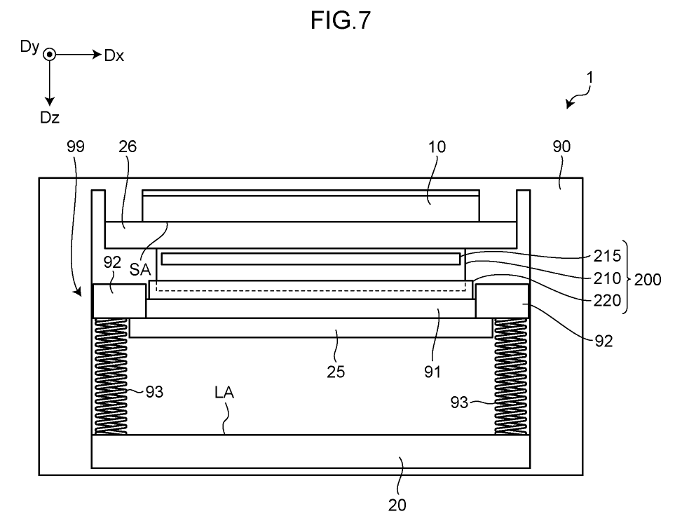

FIG. 6 is a schematic diagram illustrating a relation between one of the detection devices 1 and an external configuration. As illustrated in FIG. 6, the detection device 1 is coupled to the coupling circuit 125 by coupling the control circuit 30 to the coupling circuit 125. As illustrated in FIGS. 6 and 7, which is to be described later, the planar optical sensor 10 faces the light source panel 20. The object to be detected 200 can be placed between the planar optical sensor 10 and the light source panel 20.

FIG. 6 only schematically illustrates a rough relation between the planar optical sensor 10, the light source panel 20, and the object to be detected 200. A specific structure for placing the object to be detected 200 between the planar optical sensor 10 and the light source panel 20 will be described with reference to FIG. 7.

FIG. 7 is a schematic view illustrating a structure of various parts including main components of the detection device 1 and the object to be detected 200 placed on the detection device 1. The object to be detected 200 is a culture medium 215 (e.g., agar) accommodated in a dish 210 of a container. The container further includes a lid 220. The dish 210 is specifically a Petri dish. The lid 220 is a cover of the dish 210. The inner diameter of the annular sidewall of the lid 220 is equal to or more than the outer diameter of the annular sidewall of the dish 210. That is, the lid 220 has a cylindrical inner circumferential wall that covers a cylindrical outer circumferential wall of the dish 210 from the outside. The culture medium 215 is a culture medium capable of culturing colonies. Hereinafter, a "colony" refers to a colony of samples cultured on the culture medium 215 provided on the object to be detected 200. The samples are biological samples, such as biological tissues or microorganisms, which are assumed to be cultured on the culture medium 215. The culture medium 215 exhibits a light-transmitting property with the degree of light transmission varying depending on the presence or absence of the colony and the thickness of the colony. The object to be detected 200 is placed on a light-transmitting member 91. The light-transmitting member 91 is a plate-like member made of colorless glass or a light-transmitting colorless synthetic resin.

The light-transmitting member 91 is a circular member having a diameter that can accommodate therein the object to be detected 200 in plan view. The light-transmitting member 91 has a light-transmitting area that can accommodate therein the object to be detected 200 between the planar optical sensor 10 and the light source panel 20. The light-transmitting member 91 is in contact with a light-blocking member 92 at the outer peripheral edge. The light-blocking member 92 is a plate-like member into which the light-transmitting member 91 is fitted. The light-blocking member 92 exhibits a light-blocking property.

In the first embodiment, a diffusion plate 25 is provided on the light source panel 20 side of the light-transmitting member 91. The diffusion plate 25 is an optical member that diffuses light. The diffusion plate 25 is located to be interposed between the light-transmitting member 91 and the light-emitting area LA of the light source panel 20. When the diffusion plate 25 receives the light emitted from the light-emitting area LA from the light source panel 20 side, the diffusion plate 25 further diffuses the traveling direction of the light as the light is transmitted toward the light-transmitting member 91. This diffusion can uniform, in plan view, the light from the light-emitting area LA formed by a set of the light sources 22 that are two-dimensionally arranged.

As illustrated in FIG. 7, in the first embodiment, an elastic member 93 is provided between the light-blocking member 92 and the light source panel 20. The elastic member 93 has elasticity to urge the light-blocking member 92 toward the planar optical sensor 10. Specifically, the elastic member 93 is a cylindrical compression coil spring, as illustrated, for example, in FIG. 7. The object to be detected 200 placed on the light-transmitting member 91 is pressed against a member 26 provided between the planar optical sensor 10 and the light-transmitting member 91 by an urging force applied to the light-blocking member 92 by the elastic member 93. In the first embodiment, an object placement member 99 is configured with the light-transmitting member 91, the light-blocking member 92, and the elastic member 93. In other words, the object placement member 99 includes the light-transmitting member 91 that is a light-transmitting member on which the object to be detected is placed, and the light-blocking member 92 that is a light-blocking member supporting the light-transmitting member from the outer periphery. The diameter of a circle of an edge 95, that is, a boundary between the light-transmitting member 91 and the light-blocking member 92, is larger than the diameter of a circle of the edge of the dish 210. That is, the culture medium 215 is positioned inside the edge 95.

The member 26 serves as an optical member that limits the light that is emitted from the light-emitting area LA of the light source panel 20 and reaches the planar optical sensor 10. Specifically, the member 26 includes any of a plate-shaped louver, cylindrical openings, and microlenses. In the plate-shaped louver, a plurality of plate-like structures with plate surfaces extending along the third direction Dz are arranged in parallel. The structures are preferably made of a material having a strong light-absorbing property. The member 26 is provided along a plane (Dx-Dy plane) orthogonal to the third direction Dz. The cylindrical openings penetrate the member 26 in the third direction Dz with respect to the base of the member 26. The base is preferably made of a material having a strong light-absorbing property. The microlenses are small lenses having an optical axis along the third direction Dz. The base of the member 26 that supports the microlenses is preferably made of a material having a strong light-absorbing property. Regardless of what shape the member 26 has, the member 26 as the optical member is provided in order to limit the traveling direction of the light emitted from the light sources 22 and reaching the planar optical sensor 10 to the third direction Dz or a direction having a shallower inclination angle with respect to the third direction Dz.

A housing 90 maintains a configuration in which the light-emitting area LA of the light source panel 20 and the detection area SA of the planar optical sensor 10 face in the third direction Dz. The housing 90 is a light-blocking housing provided so as to accommodate therein in advance the light source panel 20, the elastic member 93, the diffusion plate 25, the light-transmitting member 91, the light-blocking member 92, the member 26, and the planar optical sensor 10. Placing the object to be detected 200 between the member 26 and the light-transmitting member 91 establishes the positional relation among the components illustrated in FIG. 7. In the first embodiment, the object to be detected 200 is placed on the light-transmitting member 91 so that the lid 220 side of the object to be detected 200 contacts the light-transmitting member 91. That is, the object to be detected 200 is placed between the planar optical sensor 10 and the light source panel 20 such that the lid 220 is located relatively below and the dish 210 is located relatively above.

As described above with reference to FIG. 7, the detection device 1 of the first embodiment has a structure that allows the object to be detected 200 to be placed so as to be interposed between the planar optical sensor 10 and the light source panel 20. In the placed object to be detected 200, the bottom surface of the dish 210 with the culture medium 215 provided therein extends along the detection area SA of the planar optical sensor 10 and the light-emitting area LA of the light source panel 20.

The light emitted from the light-emitting area LA of the light source panel 20 is diffused by the diffusion plate 25, passes through the light-transmitting member 91, the object to be detected 200, and the member 26, and reaches the detection area SA of the planar optical sensor 10. Thus, the planar optical sensor 10 is configured to output data reflecting the intensity of light that has been emitted from the light sources 22 and reached the optical sensors WA through the object to be detected 200. The data herein is data based on a set of the outputs from the optical sensors WA, and is, for example, an image to be described later. The intensity of the light reaching the detection area SA is affected by the degree of light transmission depending on the position of the object to be detected 200 placed on the light-transmitting member 91, the state of the culture medium 215 provided in the object to be detected 200, and other factors. As the samples to be cultured grow on the culture medium 215, the degree of light transmission changes in an area where they have grown. Thus, the growth of the samples to be cultured can be detected based on the change in intensity of the light detected by the PDs 82 included in the optical sensors WA.

As described with reference to FIG. 2, the optical sensors WA are two-dimensionally arranged along the Dx-Dy plane. Therefore, the data by the set of the outputs of the optical sensors WA can be regarded as data of the two-dimensional image. Hereinafter, the "image" refers to an image formed by a set of the outputs of the optical sensors WA, unless otherwise noted. When the images before and after the growth of the samples to be cultured are compared, portions different in brightness, that is, different in detected light intensity, appear. Such portions are regarded as the colonies where the samples to be cultured have grown.

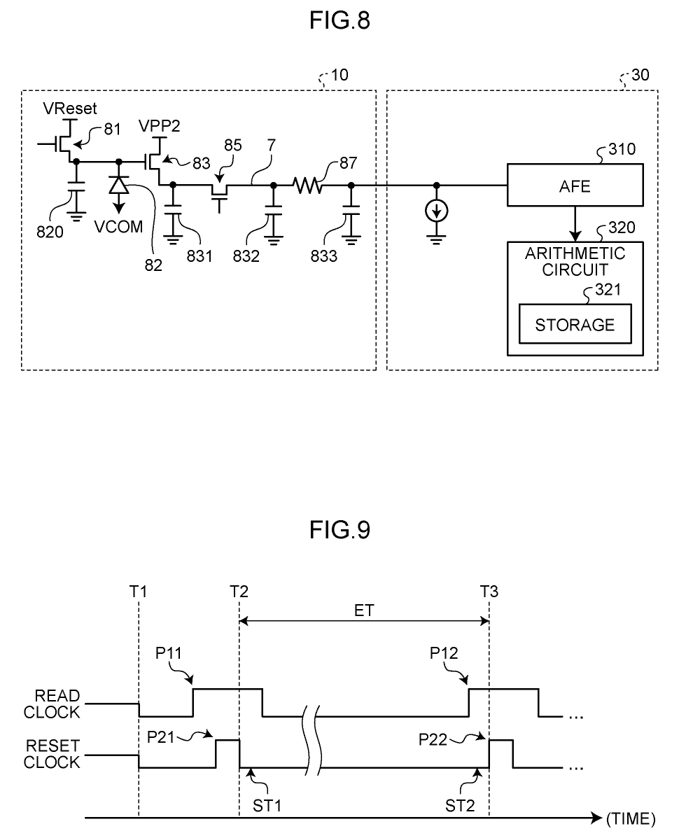

The detection device 1 of the first embodiment has the function to obtain the image from the outputs of the planar optical sensor 10. The detection device 1 of the first embodiment also has a function to detect the temperature of the planar optical sensor 10 using characteristics related to the output of the source follower transistor 83 provided in the planar optical sensor 10. The following describes the function to detect the temperature of the planar optical sensor 10 with reference to FIGS. 8, 10, and 11 to be explained below.

FIG. 8 is a schematic diagram illustrating a main configuration used for the detection of the temperature. In the configuration illustrated in FIG. 8, the switching element 81, the PD 82, the source follower transistor 83, the switching element 85, and the signal line 7 have the same configuration as that described with reference to FIG. 3.

The electromotive force caused by the PD 82 detecting the light generates capacitance between the switching element 81 and the source follower transistor 83. Capacitance 820 illustrated in FIG. 8 represents the capacitance generated by the electromotive force caused by the PD 82 detecting the light, and does not represent a capacitor as a circuit. In the same way, a ground coupled to the capacitance 820 is not as a circuit to which a signal transmission path between the switching element 81 and the source follower transistor 83 is grounded, but is conceptual.

The capacitance illustrated as the capacitance 820 is given to the gate of the source follower transistor 83. Therefore, the source potential of the source follower transistor 83 corresponds to a potential difference due to the capacitance (capacitance 820) generated by the electromotive force caused by the PD 82 detecting the light. The potential VPP2 is given to the drain of the source follower transistor 83. The reference potential VCOM is given to the anode of PD 82 coupled to the gate of the source follower transistor 83. The source follower transistor 83 in which such coupling of the drain and the gate is established serves as a source follower. That is, the output potential to the source of the source follower transistor 83 coupled to the switching element 85 follows the input potential given to the gate of the source follower transistor 83. Capacitance 831 derived from a coupling path between the source follower transistor 83 and the switching element 85 in FIG. 8 represents capacitance generated between a coupling line of the output of the source follower transistor 83 to the switching element 85 and the reference potential. That is, the capacitance 831 is not limited to a capacitor as a circuit, but can also be parasitic capacitance.

The switching element 85 is coupled to the control circuit 30 via the signal line 7, but strictly speaking, not only the signal line 7 but also a component of electrical resistance are interposed on a signal transmission path between the switching element 85 and an AFE 310 of the control circuit 30. FIG. 8 illustrates the electrical resistance component as an electrical resistor 87. Capacitance 832 is provided between the signal line 7 and the reference potential. Capacitance 833 is provided on an AFE 310 side of the electrical resistor 87. The capacitance 832 and 833 may be parasitic capacitance rather than capacitive elements as a circuit.

The AFE 310 is an analog front end (AFE) that produces a digital output signal corresponding to the capacitance 833. The AFE 310 is coupled to an arithmetic circuit 320.

The arithmetic circuit 320 is a circuit that detects the temperature of the planar optical sensor 10 based on the digital output signal of the AFE 310. The arithmetic circuit 320 of the first embodiment also performs a process to obtain the intensity of the light detected by the PD 82 based on the digital output signal of the AFE 310. Before describing a process related to the detection of the temperature, an overview of an operation timing sequence of each of the switching elements 81 and 85 used for the detection of the light intensity will be described with reference to FIG. 9.

FIG. 9 is a timing diagram illustrating the operation timing sequence of each of the switching elements 81 and 85 used for the detection of the light intensity. With reference to FIGS. 9, 10 and 11 to be explained below, description will be made assuming that the detection device 1 has started operating at time T1. In FIGS. 9-11, the switching timing between on (high) and off (low) of the gate signal given to the gate of the switching element 85 from the scan circuit 14 via the scan line 6 is illustrated as "READ CLOCK". In FIGS. 9-11, the switching timing between on (high) and off (low) of a reset signal given to the gate of the switching element 81 from the reset circuit 13 via the reset signal transmission line 5 is illustrated as "RESET CLOCK".

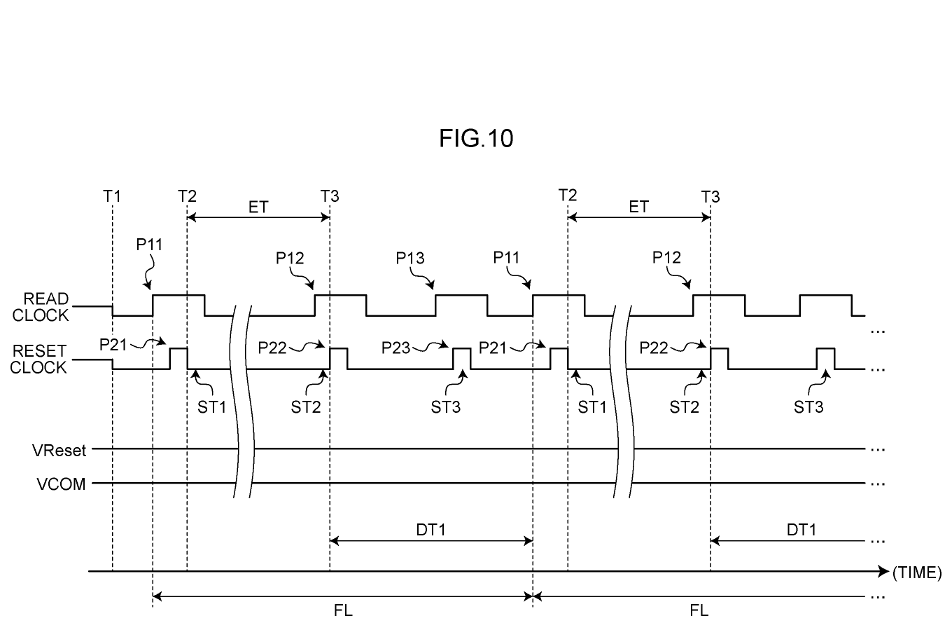

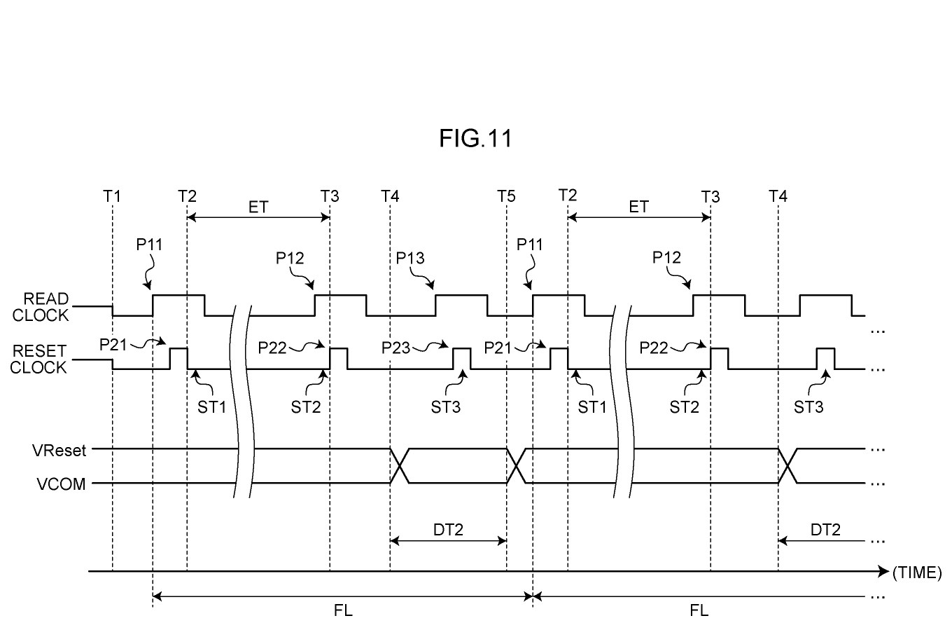

Pulses P11 and P12 illustrated in FIGS. 9-11 and a pulse P13 illustrated in FIGS. 10 and 11 are pulses during periods when the gate signal illustrated as "READ CLOCK" is on (high). During periods when none of the pulses P11, P12, and P13 is generated, the gate signal is off (low). Pulses P21 and P22 illustrated in FIGS. 9-11 and a pulse P23 illustrated in FIGS. 10 and 11 are pulses during periods when the reset signal illustrated as "RESET CLOCK" is on (high). During periods when none of the pulses P21, P22, and P23 is generated, the reset signal is off (low).

After time T1, the scan circuit 14 and the reset circuit 13 operate so that the pulses P11, P21, P12, and P22 are generated in this order. The pulse P21 is generated during the pulse P11. The start time of the pulse P21 is later than the start time of the pulse P11, and the end time of the pulse P21 is earlier than the end time of the pulse P11. The pulse P22 is generated during the pulse P12. The start time of the pulse P22 is later than the start time of the pulse P12, and the end time of the pulse P22 is earlier than the end time of the pulse P12.

In addition, as illustrated in FIG. 9, the pulses P11 and P12 and the pulses P21 and P22 are generated so that an exposure period ET is provided between the end time of the pulse P21 and the start time of the pulse P22. FIGS. 9-11 illustrate the start time of the exposure period ET as time T2. Time T2 corresponds to the end time of the pulse P21. FIGS. 9-11 illustrate the end time of the exposure period ET as time T3. Time T3 corresponds to the start time of the pulse P22.

When the signal transmission path passing between the source and the drain of the switching element 81 is established by being given the pulse P21, the reset potential VReset is given to the signal transmission path between the switching element 81 and the source follower transistor 83. This operation resets the capacitance 820 to the reset potential VReset. Therefore, the potential given to the gate of the source follower transistor 83 immediately after the pulse P21 is generated, that is, immediately after time T2, is effectively the reset potential VReset.

As described above, the end time of the pulse P11 is later than time T2. That is, at time T2, the pulse P11 continues to be provided and the signal transmission path passing between the source and the drain of the switching element 85 remains established, that is, in the conducting state. The conducting state becomes a non-connected state with the end of the pulse P11. At time ST1 between time T2 and the end time of the pulse P11, the signal transmission path passing between the source and the drain of the switching element 85 remains established. Therefore, at time ST1, the source of the source follower transistor 83 is coupled to the AFE 310 via the switching element 85, the signal line 7, and the electrical resistor 87. At this point in time, the potential given to the gate of the source follower transistor 83 is effectively the reset potential VReset, that is, the potential in the state where the PD 82 is reset, because this point in time is immediately after the pulse P21 has been generated. Therefore, the potential of the signal given to the AFE 310 from the source of the source follower transistor 83 serving as the source follower corresponds to the potential when the PD 82 is in the reset state.

During the exposure period ET between time T2 and time T3, the reset potential VReset is no longer given between the switching element 81 and the source follower transistor 83. Therefore, the capacitance 820 is increased by the photovoltaic power of the capacitance 820 correspondingly to the intensity of the light detected by the PD 82 during the exposure period ET. The start time of the pulse P12 is provided before time T3 that is the start time of the pulse P22, so that the signal transmission path passing between the source and the drain of the switching element 85 is established. Therefore, at time ST2 between the start time of the pulse P12 and time T3, the signal transmission path passing between the source and the drain of the switching element 85 is established. That is, at time ST2, the source of the source follower transistor 83 and the AFE 310 are in a coupling state via the switching element 85, the signal line 7, and the electrical resistor 87. At this time, which is immediately before the pulse P22 is generated, the potential given to the gate of the source follower transistor 83 is the potential of the capacitance 820 that has been generated correspondingly to the intensity of the light detected by the PD 82 during the exposure period ET. Therefore, the potential of the signal given to the AFE 310 from the source of the source follower transistor 83 serving as the source follower corresponds to the intensity of the light detected by the PD 82 during the exposure period ET.

The arithmetic circuit 320 obtains a signal converted into a digital signal by the AFE 310. Therefore, the arithmetic circuit 320 obtains the digital signal corresponding to the signal given to the AFE 310 at each of time ST1 and time ST2. The arithmetic circuit 320 calculates a numerical value indicating the intensity of the light detected by the PD 82 during the exposure period ET based on the difference between the digital signal obtained at time ST1 and the digital signal obtained at time ST2. Thus, the intensity of the light detected by the PD 82 is obtained.

Time ST1 and time ST2 each correspond to a predetermined time after the switching element (switching element 81) is turned from on to off. The predetermined time refers to time within 10 microseconds (μs) after the switching element (switching element 81) has been turned from on to off. In particular, time ST1 corresponds to the predetermined time during a period when the light is emitted from the light source 22, that is, a first time.

FIG. 8 illustrates an excerpt of a configuration related to one PD 82 as a configuration included in the planar optical sensor 10, but in reality, the PD 82 (refer to FIG. 3) included in each of the optical sensors WA (refer to FIG. 2) has the coupling relation with the control circuit 30 described with reference to FIG. 8.

Since the PD 82 is assumed to detect the light during the exposure period ET, the light is emitted from the light source 22 during the exposure period ET in the first embodiment. In other words, the light source 22 does not emit the light during periods that are not the exposure period ET. The light source 22 of the first embodiment operates to emit the light during the exposure period ET. That is, the image described above is obtained by the outputs of the optical sensors WA corresponding to the light emitted from the light source 22 and reaching the planar optical sensor 10 through the object to be detected 200 and other components during the exposure period ET. Therefore, a mechanism for obtaining the intensity of the light detected by the PD 82 is a mechanism for obtaining the image.

The above has described the operation timing of each of the switching elements 81 and 85 used for the detection of the light intensity and the mechanism for obtaining the intensity of the light detected by the PD 82. In the first embodiment, the operations of the switching elements 81 and 85 and the control circuit 30 used for the detection of the temperature are further performed. The following describes the operations of the switching elements 81 and 85 and the control circuit 30 used for the detection of the temperature, with reference to FIG. 10.

FIG. 10 is a timing diagram illustrating the relations of the operation timing of each of the switching elements 81 and 85 with the reset potential VReset and the reference potential VCOM in the first embodiment. As illustrated in FIG. 10, in the first embodiment, after time T1, a plurality of frame periods FL each starting from the start time of the pulse P11 are provided. In the first embodiment, for example, the scan circuit 14 and the reset circuit 13 operate so that the pulses P11, P21, P12, P22, P13, and P23 are generated in this order during one frame period FL. Of these pulses, the pulses P11, P21, P12, and P22 are generated as described with reference to FIG. 9. That is, as illustrated in FIG. 10, the frame period FL includes the exposure period ET.

The pulse P23 is generated during the pulse P13. The start time of the pulse P23 is later than the start time of the pulse P13, and the end time of the pulse P23 is earlier than the end time of the pulse P13.

As described above, the source follower transistor 83 serves as the source follower. Therefore, when the potential of the signal transmission path between the switching element 81 and the source follower transistor 83 is the reset potential VReset, no variable factor is included in conditions for determining the potential of the signal given to the switching element 85 from the source of the source follower transistor 83, except for temperature conditions. Switching elements such as the source follower transistor 83 exhibit temperature characteristics that a gate-to-source voltage (Vgs) is affected by temperature. Therefore, even when the potential of the signal transmission path between the switching element 81 and the source follower transistor 83 is fixed at the reset potential VReset, the potential given to the switching element 85 from the source of the source follower transistor 83 changes as the temperature changes. Hereinafter, "Vgs" refers to the potential of the source of the source follower transistor 83, unless otherwise noted.

Conversely speaking, if the gate potential of the source follower transistor 83 is fixed, the variable factor of Vgs is limited to the temperature in the first embodiment. That is, when the gate potential of the source follower transistor 83 is the reset potential VReset, the variable factor of the potential of the signal given to the AFE 310 via the switching element 85, the signal line 7, and the electrical resistor 87 is limited to the temperature in the same way as the variable factor of Vgs. Therefore, in the first embodiment, data is prepared to indicate the correspondence relation between the temperature of the planar optical sensor 10 and the value indicated by the digital signal from the AFE 310 obtained when the gate potential of the source follower transistor 83 is the reset potential VReset. The data is stored in a storage 321 and can be referenced by the arithmetic circuit 320. The arithmetic circuit 320 of the first embodiment refers to the data, and performs a process to detect the temperature of the planar optical sensor 10 based on the value of the signal obtained by turning on (to high) the gate signal at the time when the gate potential of the source follower transistor 83 is the reset potential VReset. The storage 321 is configured with a storage circuit provided to be referenceable by the arithmetic circuit 320 and can store data. More specifically, the storage 321 is a rewritable storage circuit such as a register or a flash memory, but is not limited thereto, and may have other configurations that function in the same way.

The data that indicates the correspondence relation between the temperature of the planar optical sensor 10 and the value indicated by the output of the AFE 310 has preferably already been processed with measures to compensate for individual product variation in the planar optical sensor 10. The value indicated by the output of the AFE 310 is a value when the gate potential of the source follower transistor 83 is at the reset potential VReset. Specifically, assume that the planar optical sensor 10 is at the reset potential VReset under the conditions where no light is emitted from the light source 22. In this state, a value indicated by a digital signal obtained from the planar optical sensor 10 is acquired in advance. This digital signal is a digital signal obtained when the gate potential of the source follower transistor 83 included in each of the optical sensors WA of the planar optical sensor 10 is at the reset potential VReset. Then, in the data, the value acquired in advance is associated with the reference temperature. As a result, even with the individual product variation in the planar optical sensor 10, more accurate temperature detection can be achieved by the planar optical sensor 10 based on more optimal data. In this case, if the planar optical sensor 10 is not at the reference temperature, a value indicated by the digital signal obtained from the AFE 310 when the gate potential of the source follower transistor 83 is at the reset potential VReset differs from the value acquired in advance. In other words, if the value corresponding to the potential of the signal from the source follower transistor 83 obtained at time ST3 differs from the value acquired in advance, the difference therebetween reflects temperature that is not the reference temperature. Here, time ST3 is an example of a time for obtaining the output of the source follower transistor 83 for the purpose of detecting the temperature. If the planar optical sensor 10 is at the reference potential, the difference is zero.

In the example illustrated in FIG. 10, during one frame period FL, a period is provided in which the pulses P23 and P13 are provided after the exposure period ET. As a result, time ST3 is provided when the gate potential of the source follower transistor 83 is at the reset potential VReset and the gate signal is on (high). That is, in the example illustrated in FIG. 10, the exposure period ET and a temperature detection period DT1 as a period for detecting temperature are independently provided.

A second time is defined as a time during a period in which the switching element (switching element 81) is on. As described above, the light source 22 does not emit light during periods that are not the exposure period ET. Therefore, time ST3 corresponds to the second time during the period when no light is emitted from the light source 22.

The arithmetic circuit 320 of the control circuit 30 obtains the output from the source of the source follower transistor (source follower transistor 83) at each of the first time (time ST1 or ST2) and the second time (time ST3). The first time is the predetermined time after the switching element (switching element 81) is turned from on to off, and the second time is a time during the period when the switching element is on. The output obtained from the source of the source follower transistor at the first time (for example, time ST1) during the period when the light is emitted from the light source 22 is an output for detecting the intensity of the light detected by the optical sensor (optical sensor WA), and the output obtained from the source of the source follower transistor at the second time (for example, time ST3) during the period when no light is emitted from the light source 22 is an output indicating first temperature that is the temperature of the planar optical sensor 10.

As described above, during the frame period FL according to the first embodiment, the process to determine the intensity of the light detected by the PD 82 and the process to detect the temperature of the planar optical sensor 10 are performed. The end time of the frame period FL is the start time of the next frame period FL. That is, at the time when a new signal regarded as the pulse P11 is generated, the previous frame period FL ends and the next frame period FL starts.

In the first embodiment, the pulses P13 and P23 can be omitted. Specifically, at least at one of the time when the pulses P11 and P21 are provided and the time when the pulses P12 and P22 are provided, the digital signal from the AFE 310 is obtained under the same conditions as those at time ST3. That is, in the first embodiment, the arithmetic circuit 320 can perform the process to detect the temperature of the planar optical sensor 10 at least at one of these times. For example, in the case of acquiring the digital signal from the AFE 310 at a time when the pulses P11 and P21 are provided under the same conditions as those at time ST3, the signal acquisition is performed as follows. In the period during which the switching element (switching element 81) is on, the second time in a period during which no light is emitted from the light source (light source 22) is provided. After the period during which the switching element is on has ended and the switching element has been turned off, the first time (for example, time ST1) is provided at a predetermined time in the period when the light source is emitting the light. Thus, the output indicating the first temperature that is the temperature of the planar optical sensor 10, and the output for detecting the intensity of the light detected by the optical sensor (optical sensor WA) are obtained in sequence.

As illustrated in FIG. 10, in the first embodiment, the reset potential VReset and the reference potential VCOM are constant. In the first embodiment, the reset potential VReset is higher than the reference potential VCOM. In the first embodiment, the potential of the signal obtained at the time for obtaining the output of the source follower transistor 83 for the purpose of detecting the temperature as illustrated at time ST3 corresponds to a potential (VReset - Vgs) obtained by subtracting Vgs from the reset potential VReset.

In the first embodiment, the temperature of the planar optical sensor 10 is detected based on the outputs of all the source follower transistors 83 of the optical sensors WA, using the source follower function of the source follower transistor 83 included in each of the optical sensors WA provided in the planar optical sensor 10. Since the temperature is not necessarily invariable over the plate surface of the planar optical sensor 10, the temperature values indicated by the outputs of the respective source follower transistors 83 may not always be the same. Therefore, the arithmetic circuit 320 may average the temperature values indicated by the outputs of the respective source follower transistors 83 as the temperature of the planar optical sensor 10. The arithmetic circuit 320 may regard the most frequent temperature value as the temperature of the planar optical sensor 10, or may use other methods to calculate temperature to be regarded as the temperature of the planar optical sensor 10. Whichever method is employed, validity of the calculation results relative to actual measurement is preferably ensured. Even during the exposure period, the output during a period when the reset is on, that is, the output during a period when the gate of switching element 81 is on, may be used as an output indicating the temperature information.

As described above, according to the first embodiment, the detection device 1 includes the light sources (light sources 22) that emit light, the planar optical sensor (planar optical sensor 10) in which the optical sensors (optical sensors WA) that detect the light from the light sources are two-dimensionally arranged, the object placement member (object placement member 99) that is provided so as to allow the object to be detected (object to be detected 200) to be placed such that the object to be detected is interposed between the light sources and the planar optical sensor, and the processor (control circuit 30) that performs the operation control of the light sources and the planar optical sensor and the processing based on the outputs of the optical sensors. The optical sensor includes the photodiode (PD 82), the source follower transistor (source follower transistor 83), and the switching element (switching element 81). The photodiode (PD 82) has the anode that is supplied with the reference potential (reference potential VCOM). The source follower transistor (source follower transistor 83) has the gate that is coupled to the cathode of the photodiode. The switching element (switching element 81) has the source and the drain, one of the source and the drain is coupled to the cathode of the photodiode and the gate of the source follower transistor, and the other of the source and the drain is supplied with the reset potential (reset potential VReset). The processor obtains the output from the source of the source follower transistor at each of the first time and the second time. The first time is the predetermined time after the switching element has been turned from on to off, and the second time is a time during the period when the switching element is on. The output obtained from the source of the source follower transistor at the first time (for example, time ST1) during the period when the light is emitted from the light sources is the output for detecting the intensity of the light detected by the optical sensor, and the output obtained from the source of the source follower transistor at the second time (for example, time ST3) during the period when no light is emitted from the light sources is the output indicating the first temperature that is the temperature of the planar optical sensor. According to the first embodiment, the intensity of the light can be detected based on the output obtained from the source of the source follower transistor at the first time (for example, time ST1) during the period when the light is emitted from the light sources. The temperature can be detected based on the output obtained from the source of the source follower transistor at the second time (for example, time ST3) during the period when no light is emitted from the light sources. Therefore, according to the detection device 1 of the first embodiment, the light intensity and the temperature can be detected.

The first temperature that is the temperature of the planar optical sensor is detected based on the difference between the output from the source of the source follower transistor (source follower transistor 83) obtained in advance under the conditions where the planar optical sensor (planar optical sensor 10) is at the reference temperature and the light sources (light sources 22) do not emit light and the output obtained from the source of the source follower transistor at the second time (for example, time ST3) during the period when no light is emitted from the light sources and the switching element (switching element 81) is on. As a result, the temperature can be detected with higher accuracy under the conditions reflecting more the individual product variation in the planar optical sensor.

Since the reset potential (reset potential VReset) is higher than the reference potential (reference potential VCOM), the photodiode (PD 82) can be more reliably reset.

The second time is provided during the period when the switching element (switching element 81) is on and no light is emitted from the light sources (light sources 22), and the first time (for example, time ST1) is provided at the predetermined time after the on-period has ended and while the light is emitted from the light sources. As a result, the switching element need not be turned on only to detect the temperature. Thus, the length of time of the entire process, including the process to detect the light intensity and the process to detect the temperature, can be easily shortened.

The optical member (member 26) for limiting the traveling direction of light is provided between the planar optical sensor (planar optical sensor 10) and the light sources (light sources 22). The traveling direction of light is a traveling direction of light emitted from the light sources and reaching the planar optical sensor. The optical member limits the traveling direction of light to a direction (third direction Dz) orthogonal to the surface for detecting the light by the planar optical sensor and a direction having a shallower inclination angle with respect to the orthogonal direction. This configuration can increase the accuracy of the relation between the lightness/darkness of light detected by the optical sensors (optical sensors WA) and the position of the object to be detected (object to be detected 200) in plan view.

Furthermore, the object to be detected 200 is placed on the light-transmitting member 91 in the state where the dish 210 with the culture medium 215 provided therein is provided at the upper position relative to the lid 220 and the lid 220 is provided at the lower position relative to the dish 210 (refer to FIG. 7). This arrangement can inhibit the upward movement and condensation of moisture evaporated from the culture medium 215. Drying of the culture medium 215 can be suppressed, and better imaging and the like of the culture medium 215 can be achieved.

### Second Embodiment

The following describes a second embodiment of the present disclosure that is partially different from the first embodiment, with reference to FIG. 11.

FIG. 11 is a timing diagram illustrating the relations of the operation timing of each of the switching elements 81 and 85 with the reset potential VReset and the reference potential VCOM in the second embodiment.

The second embodiment differs from the first embodiment in that the relative relation between the reset potential VReset and the reference potential VCOM changes between the exposure period ET and a temperature detection time. Specifically, during the exposure period ET in the second embodiment, the reset potential VReset and the reference potential VCOM are the same as those in the first embodiment. However, at the temperature detection time in the second embodiment, the values of the reset potential VReset and the reference potential VCOM are reversed from those in the first embodiment. That is, in the second embodiment, control is applied to interchange the values of the reset potential VReset and the reference potential VCOM between the exposure period ET and the temperature detection time.

FIG. 11 illustrates time T4 and time T5 as start times of the control to interchange the values of the reset potential VReset and the reference potential VCOM between the exposure period ET and the temperature detection time. FIG. 11 illustrates that the values of the reset potential VReset and the reference potential VCOM are interchanged, using a figure in which a line representing the reset potential VReset intersects a line representing the reference potential VCOM. Thus, in the second embodiment, the reset potential VReset is higher than the reference potential VCOM at the first time (for example, time ST1) during the period when the light is emitted from the light sources 22, and the reset potential VReset is lower than the reference potential VCOM during the period when no light is emitted from the light sources 22 and "the second period while the switching element (switching element 81) is on" (for example, time ST3).

In the second embodiment, the pulses P13 and P23 are generated during a temperature detection period DT2 between time T4 and time T5 while the switching between the reset potential VReset and the reference potential VCOM has already completed.

In the second embodiment, unlike in the first embodiment, the pulses P13 and P23 cannot be omitted. That is because, at the time when the pulses P11 and P21 are generated and at the time when the pulses P12 and P22 are generated, the reset potential VReset and the reference potential VCOM are the same as those in the exposure period ET. In other words, that is because the condition that the values of the reset potential VReset and the reference potential VCOM are interchanged cannot be satisfied at these times.

The second embodiment is the same as the first embodiment in that the reset potential VReset is higher than the reference potential VCOM during the exposure period ET. In contrast, the second embodiment differs from the first embodiment in that the reset potential VReset during the temperature detection period DT2 is lower than the reference potential VCOM during the temperature detection period DT2. In the second embodiment, the potential of the signal obtained at the time for obtaining the output of the source follower transistor 83 for the purpose of detecting the temperature as illustrated at time ST3 corresponds to a potential (VReset - Vf - Vgs) obtained by subtracting a potential (Vf) due to a forward voltage of the diode and Vgs from the reset potential VReset. The second embodiment is the same as the first embodiment except in the matter noted above.

As described above, according to the second embodiment, the reset potential (reset potential VReset) at the first time (for example, time ST1) during the period when the light is emitted from the light sources (light sources 22) is higher than the reference potential (reference potential VCOM), and the reset potential at the second time (for example, time ST3) during the period when no light is emitted from the light sources is lower than the reference potential. As a result, the temperature characteristics of the photodiode (PD 82) can be reflected in the output for detecting the temperature of the planar optical sensor (planar optical sensor 10). Therefore, the temperature can be detected with higher accuracy under the conditions reflecting more the individual product variation in the planar optical sensor.

### Modifications

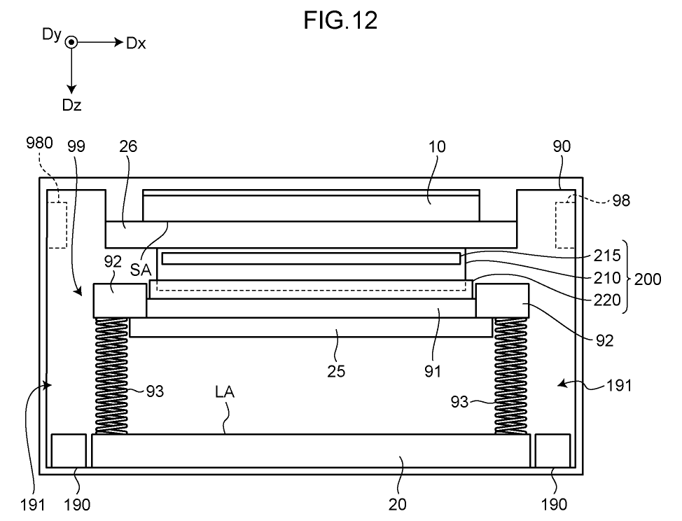

The following describes modifications of the embodiments applicable to at least one of the first and the second embodiments, with reference to FIGS. 12-16.

### First Modification

FIG. 12 is a schematic view illustrating a configuration in the housing 90 according to a first modification of the present disclosure. In the first modification, heaters 190 are provided in the housing 90 as illustrated in FIG. 12. In the modification illustrated in FIG. 12, a space 191 is provided in the housing 90 as a space for providing the heaters 190. The heaters 190 of the first modification generate heat during operation (energization).

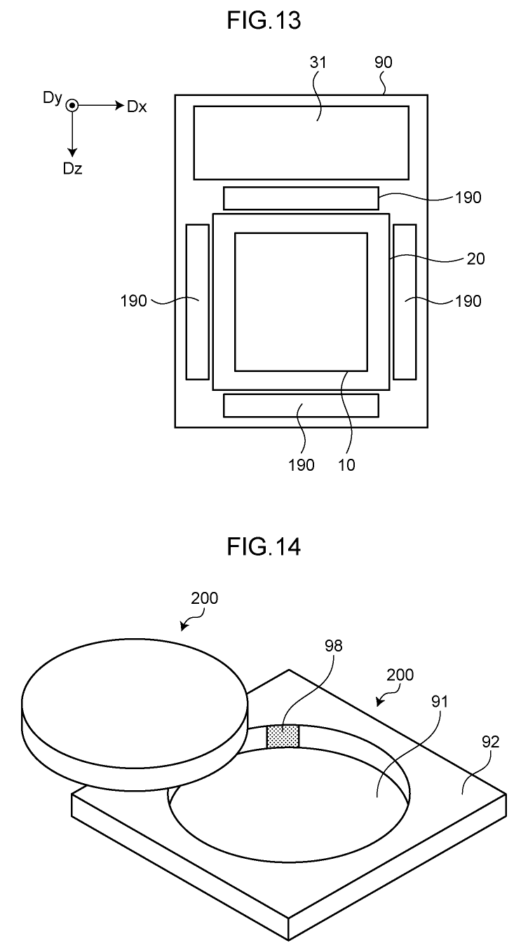

FIG. 13 is a schematic view illustrating an arrangement of the heaters 190 in plan view. As illustrated in FIG. 13, in the first modification, the multiple heaters 190 are provided along four respective sides of the rectangular light source panel 20. A substrate 31 is a substrate provided with the control circuit 30. Although FIG. 13 does not illustrate wiring between the planar optical sensor 10 and the light source panel 20 and the substrate 31, the planar optical sensor 10 and the light source panel 20 are coupled to the control circuit 30, as described with reference to FIG. 1.

In the first modification, the arithmetic circuit 320 of the control circuit 30 further controls the operation of the heaters 190 based on the temperature of the planar optical sensor 10. Specifically, the arithmetic circuit 320 operates the heaters 190 until the temperature of the planar optical sensor 10 detected by the mechanism for detecting the temperature of the planar optical sensor 10 described with reference to FIGS. 8, 10, and 11 reaches a predetermined temperature or higher. Thus, the heaters 190 operate so as to warm the inside of the housing 90 until the temperature reaches the predetermined temperature. The predetermined temperature is, for example, a temperature suitable for culturing the samples to be cultured on the culture medium 215, and is set in advance according to the samples to be cultured.

A temperature sensor 98 may be provided to detect the temperature in the housing 90 separately from the detection of temperature by the planar optical sensor 10. In this case, the arithmetic circuit 320 operates the heaters 190 until the difference between the temperature of the planar optical sensor 10 detected by the mechanism for detecting the temperature of the planar optical sensor 10 and the temperature detected by the temperature sensor 98 becomes within a predetermined range. With this operation, the difference between the temperature of the light-transmitting member 91 on which the object to be detected 200 is placed and the temperature in the housing 90 surrounding the object to be detected 200 can be easily brought closer to within the predetermined range. The predetermined range is, for example, a range from -0.1° C. to +0.1° C., but is not limited thereto. The predetermined range may be changed as appropriate from the viewpoint of achieving a more appropriate temperature in culturing the samples to be cultured on the culture medium 215.

In the description with reference to FIGS. 10 and 11, the process to obtain the output indicating the intensity of the light detected by the PD 82 during the exposure period ET and the process to obtain the output indicating the temperature of the planar optical sensor 10 are alternately performed. The detection of the light by the PD 82 may be kept from being performed until predetermined conditions are met. Examples of the predetermined conditions include, but are not limited to, that the temperature of the planar optical sensor 10 detected by the mechanism for detecting the temperature of the planar optical sensor 10 reaches the predetermined temperature described above. As another example, one of the predetermined conditions may be that the difference between the temperature of the planar optical sensor 10 detected by the mechanism for detecting the temperature of the planar optical sensor 10 and the temperature detected by the temperature sensor 98 falls within the predetermined range. One of the predetermined conditions may also be that the temperature of the planar optical sensor 10 detected by the mechanism for detecting the temperature of the planar optical sensor 10 exceeds a dew point temperature. In this case, a humidity sensor 980 is further provided in the housing 90 in addition to the temperature sensor 98 for the purpose of calculating the dew point temperature. The humidity sensor 980 is a sensor that detects relative humidity. The arithmetic circuit 320 performs operations to obtain water vapor pressure from the temperature in the housing 90 detected by the temperature sensor 98 and the relative humidity detected by the humidity sensor 980, and calculate the temperature at which the obtained water vapor pressure becomes the saturated water vapor pressure. If the dew point temperature is calculated, the implementation including an algorithm for such calculation is made in the arithmetic circuit 320 or a software program stored in the storage 321. If the software program is used, the arithmetic circuit 320 is provided as an arithmetic circuit that can read out and execute the software program. Information indicating the predetermined temperature, the predetermined range, and other information described above is also stored in advance in the storage 321.

In FIG. 12, the temperature sensor 98 is provided outside an area where the object to be detected 200 is placed. Specifically, the temperature sensor 98 illustrated in FIG. 12 is provided at a location that is apart from the light-transmitting member 91 and is on an inner wall of the space 191 in the housing 90, but is not limited to this location.

FIG. 14 is a schematic view illustrating an exemplary arrangement of the temperature sensor 98 different from that in FIG. 12. As illustrated in FIG. 14, the temperature sensor 98 may be provided, for example, at a location that is a boundary between the light-transmitting member 91 and the light-blocking member 92, and is an inner peripheral edge of the light-blocking member 92 surrounding the light-transmitting member 91. The location of the temperature sensor 98 may differ from both the location illustrated in FIG. 12 and the location illustrated in FIG. 14.

In the first modification, the incubator 120 described with reference to FIG. 5 may be omitted. This is because the heaters 190 provided inside the housing 90 enable a temperature adjusting function within the housing 90.

As described above, according to the first modification, the housing (housing 90) that accommodates therein the light sources (the light sources 22), the planar optical sensor (planar optical sensor 10), and the object placement member (object placement member 99), and the heaters (heaters 190) provided in the housing are provided. The processor (control circuit 30) controls the operation of the heaters based on the first temperature that is the temperature of the planar optical sensor. This configuration allows the heaters to heat the inside of the housing. Thus, the planar optical sensor can be induced to be heated in a warmer environment. That is, the temperature management of the planar optical sensor can be more easily performed.

The temperature sensor (temperature sensor 98) is provided outside the area where the object to be detected (object to be detected 200) is placed, and, if the difference between the second temperature detected by the temperature sensor provided outside the area of the object to be detected and the first temperature that is the temperature of the planar optical sensor (planar optical sensor 10) is within the predetermined range, the processor (control circuit 30) acquires the output obtained from the source of the source follower transistor (source follower transistor 83) at the first time (for example, time ST1) during the period when the light is emitted from the light sources (light sources 22). Therefore, the light can be more easily detected under conditions where an environment for easy growth of the samples that are cultured on the culture medium (culture medium 215) is established.

The temperature sensor (temperature sensor 98) is provided to be separated from the object placement member (object placement member 99) in the housing (housing 90). Thus, the temperature that can be detected by the temperature sensor (temperature sensor 98) can easily be made the temperature of an object different from the temperature of the planar optical sensor (planar optical sensor 10). Thus, the temperature of the environment around the planar optical sensor (planar optical sensor 10) can be more easily obtained by the temperature sensor (temperature sensor 98).

The predetermined range regarding the difference between the second temperature detected by the temperature sensor (temperature sensor 98) and the first temperature that is the temperature of the planar optical sensor (planar optical sensor 10) is stored in the storage (storage 321) included in the processor (control circuit 30). Thus, the light can be more easily detected under conditions where an environment for easy growth of the samples that are cultured on the culture medium (culture medium 215) is established.

The temperature sensor (temperature sensor 98) is provided in the housing (housing 90). If the first temperature that is the temperature of the planar optical sensor (planar optical sensor 10) is higher than the dew point temperature calculated based on the second temperature detected by the temperature sensor, the processor acquires the output from the source of the source follower transistor (source follower transistor 83) at the first time (for example, time ST1) during the period when the light is emitted from the light sources (light sources 22). Therefore, the light can be more easily detected under conditions where condensation occurs less easily. Therefore, changes in light caused by water droplets generated by the condensation can be more easily inhibited from being misidentified as colonies.

The humidity sensor (humidity sensor 980) is provided in the housing (housing 90), and the processor (control circuit 30) calculates the dew point temperature based on the humidity detected by the humidity sensor and the second temperature detected by the temperature sensor (temperature sensor 98). Therefore, the dew point temperature is obtained with higher accuracy.

### Second Modification

In the first and the second embodiments, the temperature of the planar optical sensor 10 is detected based on the outputs of all the source follower transistors 83 of the optical sensors WA. In contrast to these embodiments, in a second modification, the temperature of the planar optical sensor 10 is detected based on the outputs of some of the source follower transistors 83 of the optical sensors WA. The first modification can be combined with the second modification.

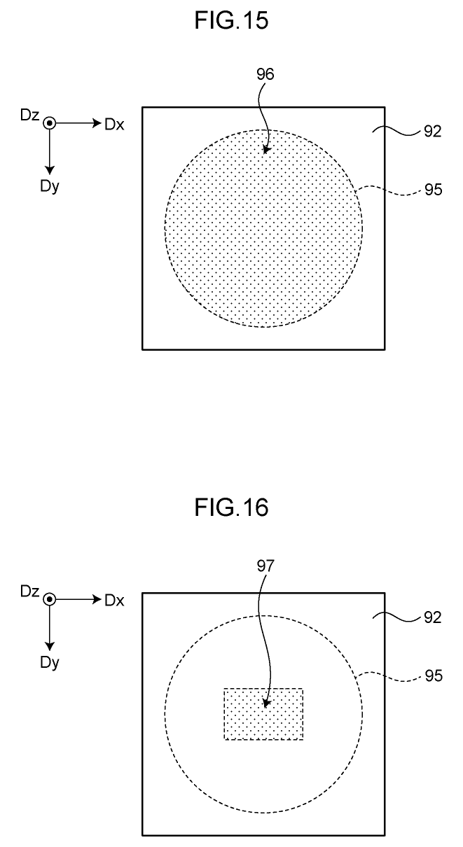

FIGS. 15 and 16 are schematic views illustrating examples of areas within which the output of the source follower transistor 83 is obtained to detect the temperature of the planar optical sensor 10. For example, the source follower transistor 83, the output of which is used to detect the temperature of the planar optical sensor 10, may be limited to the source follower transistor 83 included in the optical sensor WA disposed in an area 96 illustrated in FIG. 15 or an area 97 illustrated in FIG. 16. The area 96 is an area within the edge 95. That is, the area 96 is an area that overlaps the light-transmitting member 91 in plan view. The area 97 is an area of a portion of the inside of the edge 95. The area 97 is an area that overlaps a portion of the light-transmitting member 91 in plan view. The area 97 illustrated in FIG. 16 is rectangular in plan view, but is not limited thereto, and may have any shape.

Each of the embodiments employs the light sources 22 that each include the first light source 22R, the second light source 22G, and the third light source 22B as the light sources, but the light sources that can be employed in the embodiments according to the present disclosure are not limited to these light sources. For example, light sources corresponding to light in four or more colors of light may be employed, or light sources corresponding to one or two colors of light may be employed. Light in combined colors may also be used by simultaneously turning on some or all of a plurality of types of light sources that emit light in different colors. For example, when the first light sources 22R, the second light sources 22G, and the third light sources 22B are simultaneously turned on, white light is obtained.

The relative positional relation in the up-and-down direction between the planar optical sensor 10 and the light source panel 20 is not limited to the example illustrated in FIG. 7, and may be opposite to the relation illustrated in FIG. 7. The elastic member 93 is not essential to the object placement member 99. For example, the light-blocking member 92 may be fixed to the housing 90 so that the light-transmitting member 91 is interposed between the planar optical sensor 10 and the light source panel 20. In this case, a gap allowing the object to be detected 200 to be inserted therein is provided above the light-transmitting member 91 between the light-transmitting member 91 and the planar optical sensor 10 or the light source panel 20.

Although the lid 220 is not essential in the object to be detected 200, the lid 220 is more preferably provided in order to inhibit the entry of foreign matter in the culture medium 215. The dish 210 of the embodiments is the Petri dish, but is not limited thereto, and may be other components that serve in the same way as the Petri dish.

In the first modification, the arithmetic circuit 320 of the control circuit 30 controls the operation of the heaters 190, but the controller of the heaters 190 is not limited thereto and may be a circuit or the like independent of the control circuit 30. In this case, the independent circuit or the like can preferably reference to the information indicating the temperature of the planar optical sensor 10 obtained by the arithmetic circuit 320.

Other operational advantages accruing from the aspects described in the embodiments of the present disclosure that are obvious from the description herein, or that are conceivable as appropriate by those skilled in the art will naturally be understood as accruing from the present disclosure.

What is claimed is:

1. A detection device comprising:
a light source configured to emit light;
a planar optical sensor where a plurality of optical sensors configured to detect the light from the light source are two-dimensionally arranged;
an object placement member provided so as to allow an object to be detected to be placed such that the object to be detected is interposed between the light source and the planar optical sensor; and
a processor configured to perform operation control of the light source and the planar optical sensor and processing based on a plurality of outputs of the optical sensors, wherein
each of the optical sensors comprises:
a photodiode, an anode of which is configured to be supplied with a reference potential;
a source follower transistor, a gate of which is coupled to a cathode of the photodiode; and
a switching element, one of a source and a drain of which is coupled to the cathode of the photodiode and a gate of the source follower transistor, and the other of the source and the drain of which is configured to be supplied with a reset potential,
the processor is configured to obtain an output from a source of the source follower transistor at each of a first time and a second time, the first time is a predetermined time after the switching element has been turned from on to off, and the second time is a time during a period when the switching element is on,
the output obtained from the source of the source follower transistor at the first time during a period when the light is emitted from the light source is an output for detecting an intensity of the light detected by the optical sensor, and
the output obtained from the source of the source follower transistor at the second time during a period when no light is emitted from the light source is an output indicating a first temperature that is a temperature of the planar optical sensor.

2. The detection device according to claim 1, wherein the first temperature is detected based on a difference between an output from the source of the source follower transistor obtained in advance under conditions where the planar optical sensor is at a reference temperature and the light source emits no light and an output obtained from the source of the source follower transistor at the second time during the period when no light is emitted from the light source.

3. The detection device according to claim 1, wherein the reset potential is higher than the reference potential.

4. The detection device according to claim 1, wherein
the reset potential is higher than the reference potential at the first time during the period when the light is emitted from the light source, and
the reset potential is lower than the reference potential at the second time during the period when no light is emitted from the light source.

5. The detection device according to claim 1, wherein the second time during the period when no light is emitted from the light source is provided during the period when the switching element is on, and the first time during the period when the light source emits the light is provided after the period when the switching element is on has ended and the switching element has been turned off.

6. The detection device according to claim 1, comprising:
a housing that accommodates the light source, the planar optical sensor, and the object placement member; and
a heater provided in the housing, wherein
the processor is configured to control operation of the heater based on the first temperature.

7. The detection device according to claim 6, comprising a temperature sensor provided outside an area where the object to be detected is placed, wherein
the processor is configured to obtain, when a difference between a second temperature detected by the temperature sensor and the first temperature is within a predetermined range, the output from the source of the source follower transistor at the first time during the period when the light is emitted from the light source.

8. The detection device according to claim 7, wherein the temperature sensor is provided to be separated from the object placement member in the housing.

9. The detection device according to claim 7, wherein the predetermined range is stored in a storage included in the processor.

10. The detection device according to claim 6, comprising a temperature sensor provided in the housing, wherein
the processor is configured to obtain, when the first temperature is higher than a dew point temperature calculated based on a second temperature detected by the temperature sensor, the output from the source of the source follower transistor at the first time during the period when the light is emitted from the light source .

11. The detection device according to claim 10, comprising a humidity sensor provided in the housing, wherein
the processor is configured to calculate the dew point temperature based on humidity detected by the humidity sensor and the second temperature.

12. The detection device according to claim 1, comprising:
a housing that accommodates the light source, the planar optical sensor, and the object placement member; and
a heater provided in the housing.

13. The detection device according to claim 1, wherein an optical member is provided between the planar optical sensor and the light source to limit a traveling direction of the light emitted from the light source and reaching the planar optical sensor to a direction orthogonal to a
surface for detecting the light by the planar optical sensor and a direction having a shallower inclination angle with respect to the orthogonal direction.
